(19) United States
(12) Patent Application Publication
(10) Pub. No.: US 2011/0315487 A1
(43) Pub. Date: Dec. 29, 2011

(54) ARRANGEMENT OF ELEVATOR MACHINES

(75) Inventor: Richard N. Fargo, Plainville, CT (US)

(73) Assignee: OTIS ELEVATOR COMPANY, Farmington, CT (US)

(21) Appl. No.: 13/144,733

(22) PCT Filed: Mar. 16, 2009
(86) PCT No.: PCT/US09/37263

§ 371 Date: Jul. 15, 2011

(51) Int. Cl. B66B 11/08; B66B 7/06

(52) U.S. Cl. 187/258

(57) ABSTRACT

A drive (50) for a gearless elevator (10) includes a first drive machine (52) with a first sheave having a first axis of rotation, the first sheave to receive a first set of ropes (20A) attached to the elevator car (12), and a second drive machine (54) having a second sheave having a second axis of rotation, the second sheave to receive a second set of ropes (20B) attached to the elevator car (12). The first axis of rotation and the second axis of rotation are parallel, and have a distance therebetween.

### BACKGROUND

The present disclosure relates generally to an elevator system, and more particularly to an elevator system including a drive having a plurality of motors for operating a single elevator car.

A typical traction elevator system includes a car and a counterweight disposed in a hoistway, a plurality of ropes that interconnect the car and counterweight, and a machine having a traction sheave engaged with the ropes. The drive machine of the traction elevator has a traction sheave with grooves for the hoisting ropes of the elevator and an electric motor driving the traction sheave either directly or through a transmission. The ropes are driven by rotation of the traction sheave that results in repositioning of the car and counterweight within the hoistway. The traction machine, and its associated electronic equipment, along with peripheral elevator components, such as a governor and safety features, are housed in a machine room located above the hoistway.

Conventional traction machines make use of permanent magnets in the rotor in order to improve the efficiency of the machine. The conventional stock machines, however, are limited to relatively low duties and low speeds. These types of machines are impractical for newer buildings, which are constructed at greater and greater vertical heights that the elevators must service. Existing machines reach their design limits for structures that are greater than 500 m, which is becoming more and more common.

One of the problems encountered in gearless elevator machines of conventional construction has been their large size and weight. Such motors take up considerable space and are difficult to transport to the site and to install. In large elevator machines, transmitting the torque from the drive motor to the traction sheave can be a problem. For elevators designed for loads of several thousand kg and speeds of several meters per second, none of the prior art is capable of developing a sufficient torque and speed of rotation with a conventional machine with a single motor of acceptable size and weight. This imposes special requirements on the electric drive of the motor to allow full-scale utilization of the motor, and the size of the motor becomes unwieldy. Specialized equipment and large cranes are required for getting such motors in place during construction of structures of great vertical height. Further, the size of the motors and machines and area required might be greater than that of the cross-sectional area of the hoistway of the elevator, again requiring specialized mounting arrangements. Special requirements generally result in a complicated system or a high price, or both.

Thus there is a need in the art to develop elevator systems that efficiently utilize the available space and meet the duty load and speed requirements over a broad range of elevator applications, including tall vertical structures. Further, there is a need for a machine that is easily installed, and can be positioned by hoisting the machine through the hoistway with common building cranes.

### SUMMARY

In one embodiment, a drive for a gearless elevator includes a first drive machine with a first sheave having a first axis of rotation, the first sheave to receive a first set of ropes attached to the elevator car, and a second drive machine having a second sheave having a second axis of rotation, the second sheave to receive a second set of ropes attached to the elevator car is disclosed. The first axis of rotation and the second axis of rotation are parallel, and have a distance therebetween.

In another embodiment, an elevator system having an elevator car within a hoistway, a counterweight, a plurality of ropes connecting the elevator car and the counterweight, and a drive apparatus is disclosed. The drive apparatus has a first drive machine with a first sheave, a second drive machine with a second sheave, and a deflector sheave. A first set of said plurality of ropes engage the first sheave, a second set of said plurality of ropes engage the second sheave, and all of said plurality of ropes engage said deflector sheave.

In yet another embodiment, a drive for an elevator having a plurality of drive machines for driving an elevator car is disclosed. Each of the plurality of drive machines contain a sheave with an axis, each axis parallel to the rest of the sheave axes, and each axis of the plurality of machines is spaced from adjacent axes.

### BRIEF DESCRIPTION OF THE DRAWINGS

FIG. 1 is a perspective view of a typical gearless traction elevator.

FIG. 2 is an elevation view of a machine drive for a gearless traction elevator.

FIG. 3 is a front elevation view of the machine drive in FIG. 2.

FIG. 4 is a side elevation view of another embodiment of a machine drive for a gearless traction elevator.

FIG. 5 is a side elevation view of yet another embodiment of a machine drive for a gearless traction elevator.

FIG. 6 is a side elevation view of another embodiment of a drive for a traction elevator.

### DETAILED DESCRIPTION

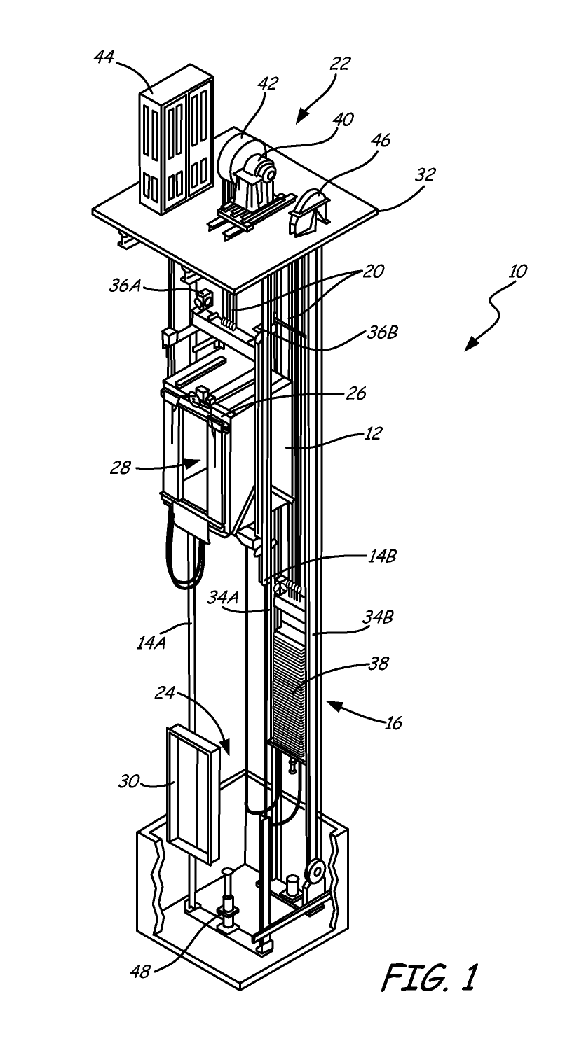

FIG. 1 is a perspective view of a typical gearless traction elevator 10. Illustrated in FIG. 1 is an elevator 10 which includes a car 12 in hoistway 24, a pair of car guide rails 14A and 14B, a counterweight 16, a pair of counterweight guide rails 18A and 18B, a plurality of ropes 20 interconnecting car 12 and counterweight 16, and traction machine 22 engaged with ropes 20 on top of hoistway ceiling 32.

Car 12 includes a frame 26 and opening 28. Opening 28 will align with door 30 in hoistway 24 allowing access to car 12. Opening 28 may contain a door attached to car 12, which may be a singular panel, or multiple panel telescopic or center opening design. Door 30 will be adjacent a floor of the structure housing elevator 10, with the floor of car 12 approximately parallel to the landing surface in front of door 30. Again, door 30 may be a singular panel, or multiple panel telescopic or center opening design. Although illustrated with a singular door 30, Elevator 10 may include a plurality of doorways on a plurality of different floors or stories of the structure housing elevator 10. A set of rollers 36A and 36B are attached to the top of car 12. Rollers 36A and 36B position car 12 against guide rails 14A and 14B to facilitate vertical movement of car 12 within hoistway 24 while minimizing other motion, i.e., swaying of car 12 within hoistway 24.

Car 12 and counterweight 16 are connected to one another by the ropes 20 to move concurrently and in opposite directions within hoistway 24. Counterweight 16 is positioned in hoistway 24 adjacent car 12. Counterweight 16 may be secured to guide rails 14A and 14B, or to a separate supporting structure, such as counterweight rails 34A and 34B.

Car 12 and counterweight 16 are connected through ropes 20. The present invention could utilize any suitable rope. For example, ropes 20 may be round ropes made steel wire or flat belts that have a flexible jacket, such as a polyurethane material, disposed around cores, made for example from steel wire. For example, rope 20 may be composed of six or eight strands, with each strand containing 19 or 25 wires per strand, wrapped around galvanized and polypropylene or natural fiber core. Ropes 20 should be flexible with a minimal elongation for a minimum breaking length, which adds to the safety of the elevator system.

The traction machine 22 engages the ropes 20. Traction machine 22 has motor 40, sheave 42, brake, bearings, and other components known in the art. Sheave 42 has an arrangement for interacting with rope 20. The design of the sheave, therefore, will depend on the type of rope 20 used in elevator 10. Sheave 42 may be coaxial with motor 40, and may be directly driven by motor 40, such as being attached to the rotor or, in some instances, may a part integral with the rotor shaft. In other embodiments, sheave 42 is attached to motor 40 through a transmission gearbox. Motor 40 could be an alternating current (AC) or direct current (DC) electrical motor. In one embodiment, motor 40 could be a permanent magnet AC gearless machine, with a maximum allowable sheave shaft load of 100,000 Kg, and provides a car speed of 4.0 to 10.0 m/s.

In the embodiment shown in FIG. 1, traction machine 22 is located in a machineroom above the top 32 of the hoistway, along with controller 44 and governor 46. In other embodiments, the traction machine 22 could be located within the hoistway in a machineroomless configuration. Controller 44 performs operational control of elevator 10. Operational control includes adjusting motor speed, including starting and stopping of car 12 at the appropriate locations along hoistway 34, as well as acceleration, velocity, and deceleration of car 12 within hoistway 34. Controller 44 also coordinates car calls within the structure housing elevator 10, providing visual indication of car 12 location, and communicating to passengers relevant car information. In other embodiments, controller 44 is located elsewhere in the structure that houses elevator 10.

Governor 46 acts as a safety mechanism for elevator 10. Governor 46 is activated by car speed, and will activate system brakes at a predetermined speed. Elevator 10 may also contain other safety structures, such as car buffer 48. Car buffer 48 is a shock absorbing system, and may include a piston in an oil-filled cylinder, springs, or similar structures known to those in the art. In addition to these safety features, controller 44 may incorporate safety features, such as controllable electromagnetic brakes or a system that determine whether operation of car 12 is safe.

The design described works well for typical structures. However, with tall structures, many problems can be encountered. For example, if a single traction machine is to be used, the size must be increased to support the increased power requirements. This creates space problems as the machine may be larger than the cross-sectional area of the hoistway. Additionally, very large machines are difficult to transport to the jobsite, and may require specialized equipment to install.

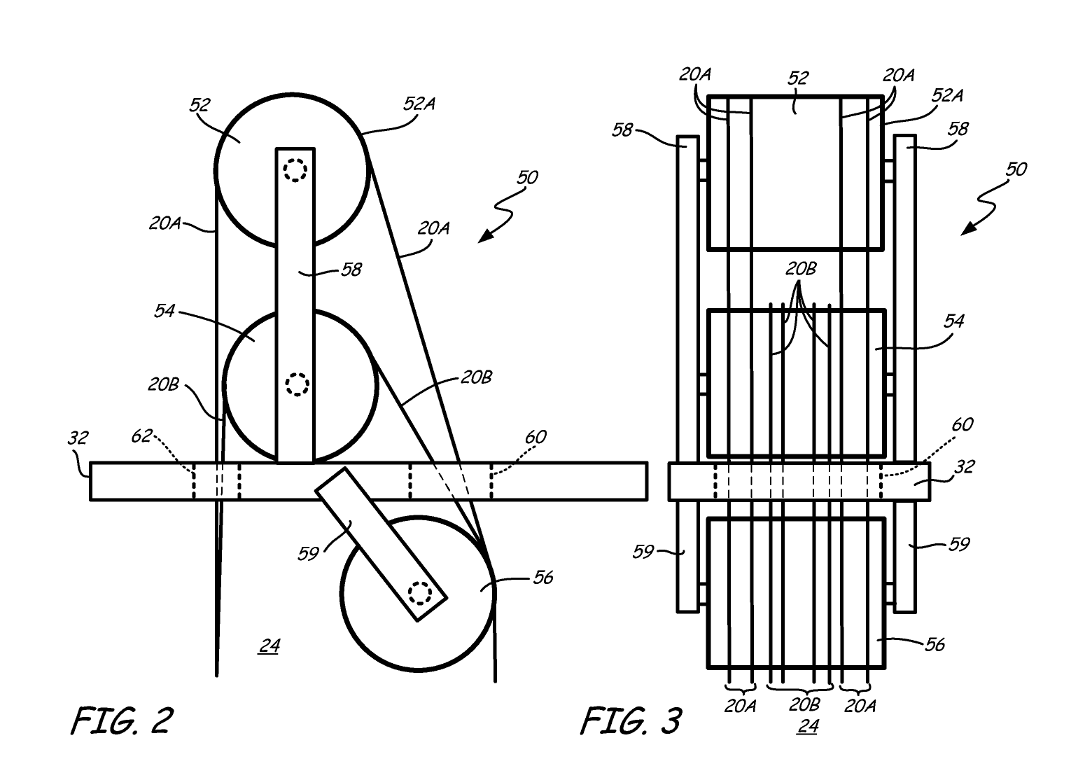

FIG. 2 is a side schematic elevation view of one embodiment of a traction machine system 50 of the present invention for elevator 10, and FIG. 3 is a front schematic elevation view of traction machine drive 50. Illustrated are traction machine system 50 having first traction machine 52 and second traction machine 54 above deflector 56. Traction machine system 50 provides the motive power to a single elevator car contained within hoistway 24. In alternate embodiments, traction machine 50 provides the motive power for a plurality of cars within hoistway 24 that share a common set of ropes 20A and 20B. First traction machine 52 and second traction machine 54 can be permanent magnetic AC motors with a rotor directly connected to sheaves similar to the embodiments of traction machine 22 described above. Both traction machines 52 and 54 can also have identical specifications.

Traction machines 52 and 54 are mounted in one embodiment such that first traction machine 52 is spaced vertically above traction machine 54. First traction machine 52 contains a sheave with first axis of rotation, and second traction machine contains a sheave with second axis of rotation. The first axis of rotation and the second axis of rotation are parallel and have a distance therebetween. Both traction machine 52 and 54 are centered on an axis that is parallel to the path of car 12 within hoistway 24. Traction machine system 50 and ropes 20A and 20B could reside within the cross-sectional area of hoistway 24. The tandem arrangement of traction machines 52 and 54 allow the functions of the motor, brake, and bearing load to be distributed between two machines, resulting in much smaller machines.

Traction machine drive 50 can mount to the machine room through support 58. Support 58 is illustrated as a structural beam capable of supporting both traction machines 52 and 54. In other embodiments, first and second traction machines 52 and 54 contain separate support structures, which may be triangular in shape.

A first set of ropes 20A are wrapped around first traction machine 52. In one embodiment, the ropes 20A could be positioned adjacent the lateral sides of the sheave 52A of the first traction machine 52. A second set of ropes 20B are wrapped around traction machine 54. With the arrangement of ropes 20A described above, the ropes 20B could be positioned centrally so as to not cross or otherwise interfere with ropes 20A. Another possible arrangement is for the first set of ropes 20A to reside on one side of the sheave for the first traction machine 52 and the second set of ropes 20B to reside the opposite side of the sheave for the second traction machine 54. With any roping arrangement, both sets of ropes 20A and 20B extend down and contact deflector 56 through front aperture 60, and are symmetrically arranged on deflector 56. Deflector 56 is an idler sheave, or a similar non-powered pulley structure that is allowed to rotate about a central axis. Deflector 56 is mounted in hoistway 24 through brace 59. In one embodiment (not illustrated), deflector 56 is attached to car 12.

Ropes 20A can wrap around traction machine 52 at an angle of close to 180 degrees, while ropes 20B can wrap around traction machine 54 at an angle several degrees less than the wrap of ropes 20A around traction machine 52. Deflector 56 aligns both ropes 20A and 20B as they extend down and attach to car 12. The opposite ends of ropes 20A and 20B can hang approximately parallel, extend down into hoistway 24, and attach to counterweight 16 through aperture 62. Other terminations of the roping are, however, possible.

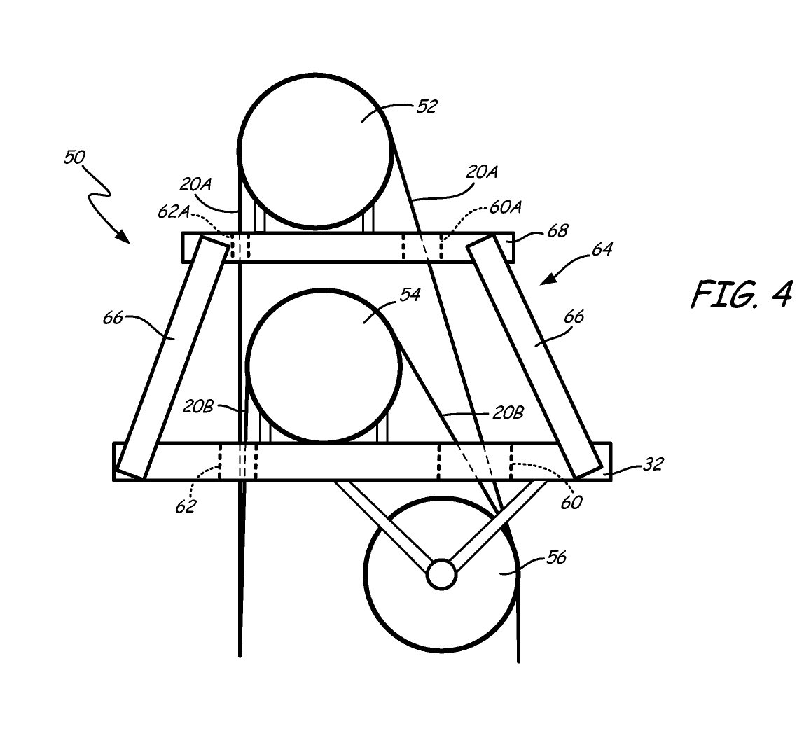

FIG. 4 is a side elevation schematic view of an alternate embodiment for traction machine system 50. Illustrated are traction machine system 50 having first traction machine 52 and second traction machine 54 in the machineroom, and deflector 56 in the hoistway 24. First traction machine 52 and second traction machine 54 can be permanent magnetic AC motors connected to sheaves through coaxial shafts. Traction machines 52 and 54 can be mounted such that first traction machine 52 is spaced vertically above traction machine 54. Other arrangements, however, are possible. Second traction machine 54 is secured to the floor of the machineroom (i.e. the hoistway ceiling 32). First traction machine 52 is secured to support structure 64 that can have angled side supports 66 and horizontal support 68. Supports 66 and 68 are constructed from structural beams or similar structures known within the art. The bases of traction machines 52 and 54 are secured to the respective supporting structures, such as with fasteners or by weldments.

Again, both traction machines 52 and 54 are centered on an axis that is parallel to the path of car 12 within hoistway 34. Traction machine system 50 and ropes 20A and 20B can all be contained within the cross-sectional area of hoistway 24. Ropes 20A and 20B can be wrapped similar to that illustrated in FIG. 2. Ropes 20A extend from traction machine 52 through apertures 60A and 62A in horizontal support 68. Ropes 20A and ropes 20B all extend through apertures 60 (contacting deflector 56) and 62, where one end is attached to car 12 and another end is attached to counterweight 16. Ropes 20A and 20B can be symmetrically spaced on traction machines 52 and 54 and deflector 56.

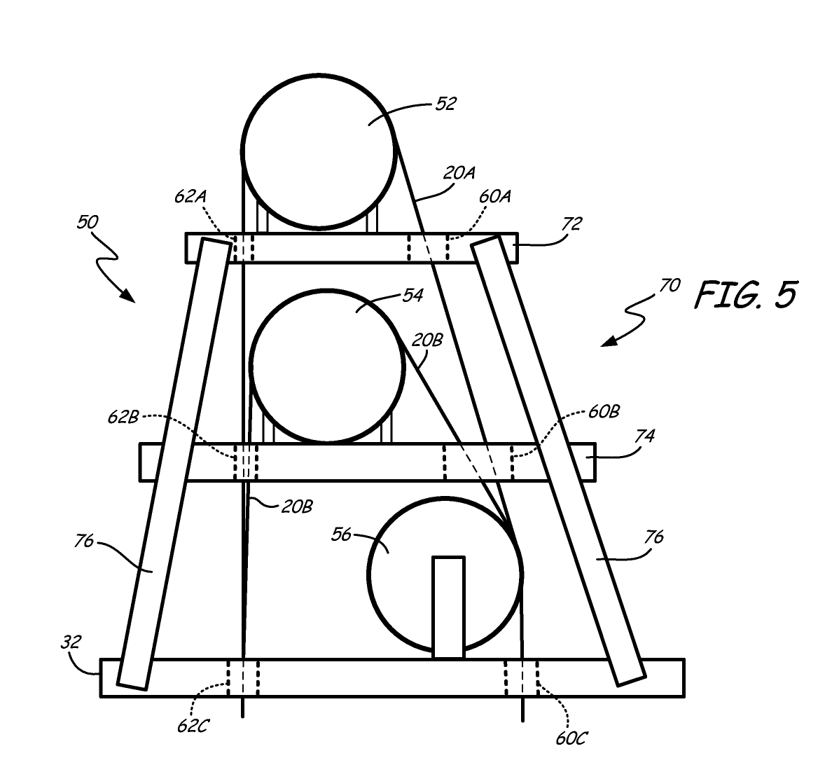

FIG. 5 is side elevation schematic view of another embodiment for traction machine drive 50. Illustrated are traction machine system 50 having first traction machine 52 and second traction machine 54, and deflector 56 within the machineroom. First traction machine 52 and second traction machine 54 could be permanent magnetic AC motors with sheaves attached thereto as previously described.

In this embodiment, deflector 56 could be mounted to the machineroom floor (i.e. the hoistway ceiling 32). Traction machine drive 50 is attached to the machineroom floor through support system 70. Support system 70 could contain first horizontal support 72, second horizontal support 74, and vertical braces 76. First traction machine 52 is secured to first horizontal support 72 and second traction machine 54 is secured to second horizontal support 74. Both first and second horizontal supports are secured to hoistway ceiling through vertical braces 76. Braces may be parallel in one embodiment, or may be angled in another. Support system 70 is constructed from structural beams, metal plates, fasteners, and similar items that are known within the art.

Again, ropes 20A are wrapped around first traction machine 52, and ropes 20B are wrapped around traction machine 54 in any of the previously discussed arrangements. Both sets of ropes 20A and 20B extend down and contact deflector 56 through front aperture 60. Deflector 56 is an idler sheave, or a similar non-powered pulley structure that is allowed to rotate about a central axis. Deflector 56 is sized to be of an axial length that allows for all ropes 20A and 20B to contact the sheave. In alternate embodiments, deflector 56 may be a plurality of sheaves mounted to hoistway ceiling 32.

Ropes 20A can wrap around traction machine 52 at an angle of close to 180 degrees, while ropes 20B can wrap around traction machine 54 at an angle several degrees less than the wrap of ropes 20A around traction machine 52. Deflector 56 aligns ropes 20A and 20B as they extend down and attach to car 12 (not illustrated). The portions of ropes 20A and 20B that extend from the opposite side of traction machines 52 and 54 can hang generally parallel to each other, as well as generally parallel to the portion of the ropes 20A and 20B extending from deflector 56 extending down into hoistway 24.

In all of the above designs, first traction machine 52 and second traction machine 54 cooperatively act to provide motive power to the elevator 10. First traction machine 52 and second traction machine 54 can both be connected to controller 44. In one embodiment, the traction machines are connected and operate in a master/slave relationship. In this arrangement, one machine will be a master with a closed loop speed, and the other produces the same torque as the master. In some embodiments, both traction machines 52 and 54 can have motors that contain identical specifications. In alternate embodiments, each motor contains a differing specification.

Ropes 20A and ropes 20B can be symmetrically spaced with respect to one another. The symmetrical spacing of ropes, along with the positioning of the ropes by deflector 56, minimizes the off-balancing of the elevator car should the first traction machine 52 and the second traction machine drive 54 vary in torque or speed from one another. Thus, the symmetric arrangement of ropes prevents tipping of car 12.

The above disclosed designs can have traction machine system 50 within the projection of hoistway 24. That is, traction machine drive and all other related components are mounted in an area that is equal or less than the cross-sectional area of the hoistway 24. Such design criteria keep the area required for an elevator in a structure to a minimum, thus maximizing usable space for the structure. Traction machine drive 50 contains two smaller machines that replace the need for a singular larger machine. Specialized machinery need not be used for installation, and stock machines can be used in combination to provide the required power even in the tallest of structures. Thus, there is no need to produce a small number of extremely large machines. Instead, a designer can utilize existing machine designs in combination to obtain required performance. Although all embodiments are illustrated as being mounted above the hoistway ceiling, embodiments are envisioned where a plurality of drive machines are contained within the hoistway below the hoistway ceiling.

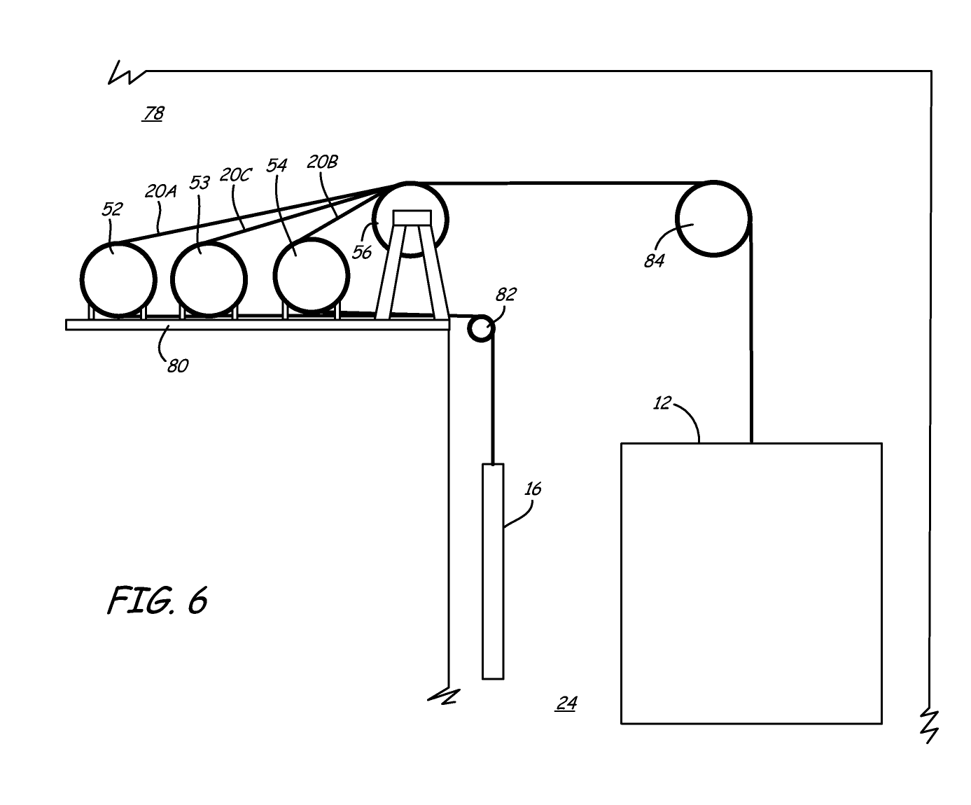

Although the illustrated embodiments all contain two machines, any number of machines may be used. FIG. 6 is a side elevation view of yet another embodiment of a traction machine drive for a gearless traction elevator. In this embodiment, the traction machine drive has three machines 52, 53, and 54. Each machine 52, 53, 54 has a motor, sheave, bearings, and brake. The sheave of each machine 52, 53, and 54 has axis of rotation parallel to the others, and each axis is spaced from the others. A set of ropes 20A, 20C, and 20B extend around each machine 52, 53, 54, respectively, and contact deflector 56. The angle of wrap of ropes on each machine will increase with the spacing of the machine from deflector 56. Machines 52, 53, and 54, as well as deflector 56, are mounted in machine room 78 on surface 80, which may be a floor or roof of the structure containing the elevator system. Machine room 78 containing machines 52, 53, and 54 may be used in a structure where there is limited room adjacent the top of hoistway 24.

Ropes 20A, 20B, and 20C each contain a first end that extends around deflector 56 to a second deflector 84 and connect to car 12 in hoistway 24. A second end of ropes 20A, 20C, and 20B extend from machines 52, 53, and 54 to a third deflector 82 and attach to counterweight 16. In this design, all machines 52, 53, and 54 cooperatively act to provide motive power to the elevator 10, and are all connected to controller 44.

Although the present invention has been described with reference to preferred embodiments, workers skilled in the art will recognize that changes may be made in form and detail without departing from the spirit and scope of the invention.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A drive for an elevator, the drive comprising:
a first drive machine having a first sheave to receive a first set of ropes that attach to an elevator car, the first sheave having a first axis of rotation; and
a second drive machine having a second sheave to receive a second set of ropes that attach to the elevator car, the second sheave having a second axis of rotation;
wherein the first axis of rotation and the second axis of rotation are parallel and have a distance therebetween.

2. The drive of claim 1 wherein the first drive machine is separated from the second drive machine by a support structure.

3. The drive of claim 1 further comprising:
a deflector sheave that aligns the first set of ropes and second set of ropes with respect to the elevator car.

4. The drive of claim 1 wherein the first drive machine and second drive machine are configured in a master/slave relationship.

5. The drive of claim 1, wherein the first drive machine is vertically spaced from the second drive machine.

6. An elevator system comprising:
an elevator car within a hoistway;
a counterweight;
a plurality of ropes connecting the elevator car and the counterweight; and
a drive apparatus comprising:
a first drive machine with a first sheave;
a second drive machine with a second sheave; and
a deflector sheave; and
wherein a first set of said plurality of ropes engage the first sheave, a second set of said plurality of ropes engage the second sheave, and all of said plurality of ropes engage said deflector sheave.

7. The elevator system of claim 6 wherein the first drive machine is located above the second drive machine.

8. The elevator system of claim 6 wherein a wrap angle of the first set of ropes is greater than a wrap angle of the second set of ropes.

9. The elevator system of claim 6 wherein the first set of ropes and the second set of ropes are symmetrically arranged around the deflector sheave.

10. The elevator system of claim 6 wherein the first drive machine and second drive machine are identical.

11. The elevator system of claim 6 wherein the first drive machine is separated from the second drive machine by a support structure.

12. The elevator system of claim 6 wherein the deflector sheave is located below the ceiling of the hoistway.

13. The elevator system of claim 6 wherein the first drive machine and the second drive machine are configured in a master/slave relationship.

14. The elevator system of claim 6 wherein the first drive machine and the second drive machine are mounted on the same support structure.

15. A drive for an elevator, the drive comprising:
a plurality of drive machines for driving an elevator car;
wherein each of the plurality of drive machines contain a sheave with an axis, each axis parallel to the rest of the sheave axes, and each axis of the plurality of machines is spaced from adjacent axes.

16. The drive of claim 15 wherein the plurality of drive machines are identical.

17. The drive of claim 16 wherein the plurality of drive machines are separated from each other by a support structure.

18. The drive of claim 16 further comprising:
a separate set of ropes wrapped around the sheaves of each of the plurality of machines.

19. The drive of claim 18 wherein the separate sets of ropes are symmetrically arranged around the deflector sheave.

20. The drive of claim 15 wherein the plurality of machines are configured in master/slave relationships.
